(19) United States
(12) Patent Application Publication
(10) Pub. No.: US 2006/0274902 A1
(43) Pub. Date: Dec. 7, 2006

(54) Audio processing

(76) Inventors: Oliver George Hume, London (GB); Jason Anthony Page, Buckinghamshire (GB)

Correspondence Address: KATTEN MUCHIN ROSENMAN LLP, 575 MADISON AVENUE, NEW YORK, NY, 10022-2585, US

(21) Appl. No.: 11/429,465

(22) Filed: May 5, 2006

(30) Foreign Application Priority Data
May 9, 2005 (GB) 0509426.3

(51) Int. Cl. H04R 5/00

(52) U.S. Cl. 381/17

(57) ABSTRACT

An audio processing apparatus operable to determine, for each loudspeaker of a plurality of loudspeakers, the respective volume at which an audio signal is to be output through that loudspeaker, the volume being determined in dependence on a desired characteristic of a simulated source for the audio signal, the position of a listening location for listening to the audio signal and the position of the loudspeaker.

### BACKGROUND OF THE INVENTION

1. Field of the Invention

This invention relates to audio processing.

2. Description of the Prior Art

Audio systems that use two or more loudspeakers are well known. These range from the relatively simple stereo systems that use two loudspeakers to the more complex surround-sound systems, such as DTS and Dolby Digital systems that may use six (for 5.1 surround-sound), seven (for 6.1 surround-sound) or eight (for 7.1 surround-sound) loudspeakers.

By using multiple loudspeakers, it is possible to impose a feeling of a desired direction/origin for an audio channel, so that a listener is able to determine where the sound appears to originate from. For example, a simple stereo system using a left and a right loudspeaker outputs a sound louder from the left loudspeaker than the right loudspeaker to produce the effect of that sound originating from the left hand side. The interference of the sound wave from the left loudspeaker with the same sound wave (but with reduced amplitude) from the right loudspeaker results in a sound wave appearing to reach a listener's left ear before his right ear, thus creating the sense of direction for that sound (or a sense of origin for the source of that sound).

The use of six, seven or eight loudspeakers allows the current surround-sound systems to generate more complex effects. When a listener is situated inside the “circle” of loudspeakers that these surround-sound systems use, a sound can be made to appear as if it has originated from almost any position around the listener (e.g. in front, to the side or behind). As with the stereo approach, the surround-sound effects are generated by outputting the same audio signal from each loudspeaker whilst controlling the volume at which this audio signal is output on a loudspeaker-by-loudspeaker basis.

A problem with these systems often arises due to the physical characteristics of the room within which the system is located. For example, it may not be possible to arrange the eight loudspeakers of a 7.1 surround-sound system in their ideal positions due to, for example: the room being an odd shape; the presence of doors or the need to leave certain areas clear of loudspeakers; and the presence of furniture limiting where the loudspeakers may be located. This can produce noticeable degradation in the quality of the surround-sound effects: for example, a sound that is intended to appear to originate from the front left may, due to the actual loudspeaker positioning, appear to originate from the front centre.

### SUMMARY OF THE INVENTION

According to an embodiment of the invention, there is provided an audio processing apparatus operable to determine, for each loudspeaker of a plurality of loudspeakers, the respective volume at which an audio signal is to be output through that loudspeaker, the volume being determined in dependence on a desired characteristic of a simulated source for the audio signal, the position of a listening location for listening to the audio signal and the position of the loudspeaker.

Embodiments of the invention have an advantage that the volumes at which the loudspeakers output an audio signal are controlled according to a listening location (such as where a person will sit to listen to the audio), a desired characteristic when simulating the source of the audio signal (such as the location and/or size of the sound source, and/or the size of the room/environment in which the sound source is intended to appear to be located) and the actual position of the loudspeakers. Thus, the above-mentioned room constraints for positioning loudspeakers can be overcome by controlling the loudspeaker volumes in this way to create the surround-sound effects as intended by the author of the audio.

Further respective aspects and features of the invention are defined in the appended claims. BRIEF DESCRIPTION OF THE DRAWINGS

The above and other objects, features and advantages of the invention will be apparent from the following detailed description of illustrative embodiments which is to be read in connection with the accompanying drawings, in which:

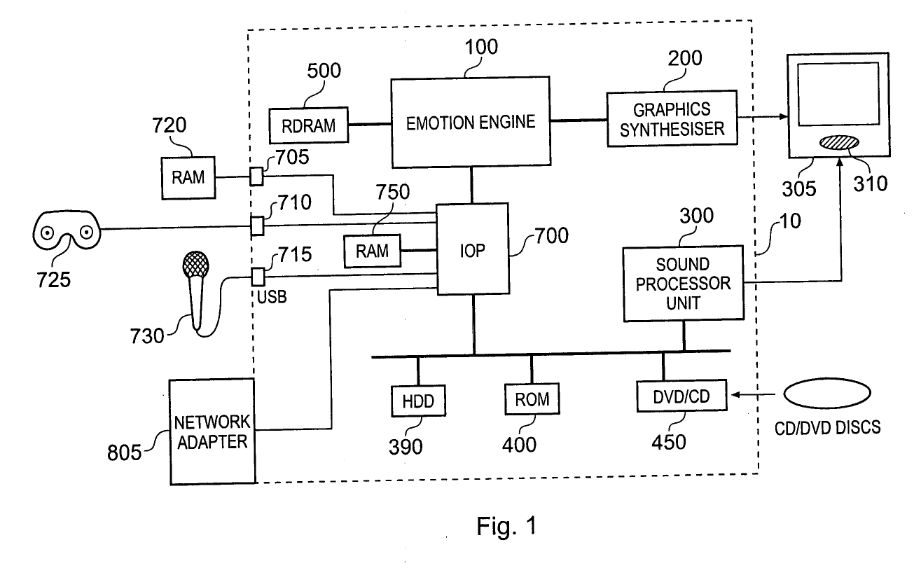

FIG. 1 schematically illustrates the overall system architecture of the PlayStation2:

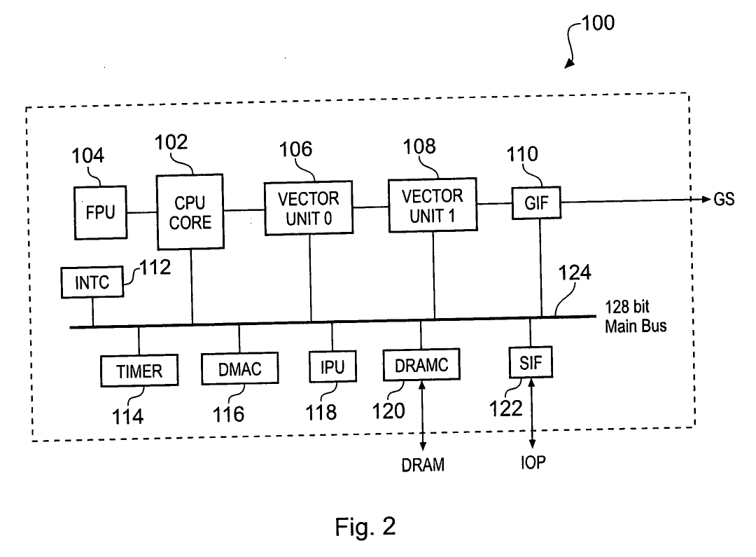

FIG. 2 schematically illustrates the architecture of an Emotion Engine;

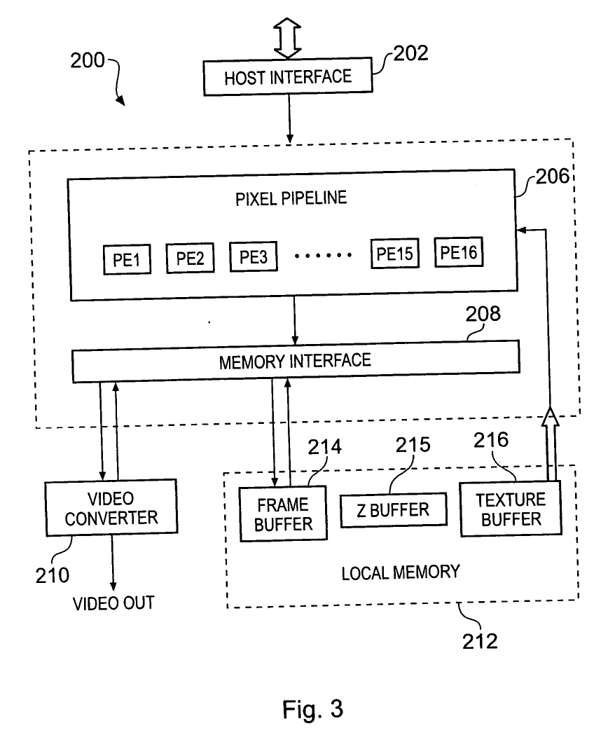

FIG. 3 schematically illustrates the configuration of a Graphics Synthesiser;

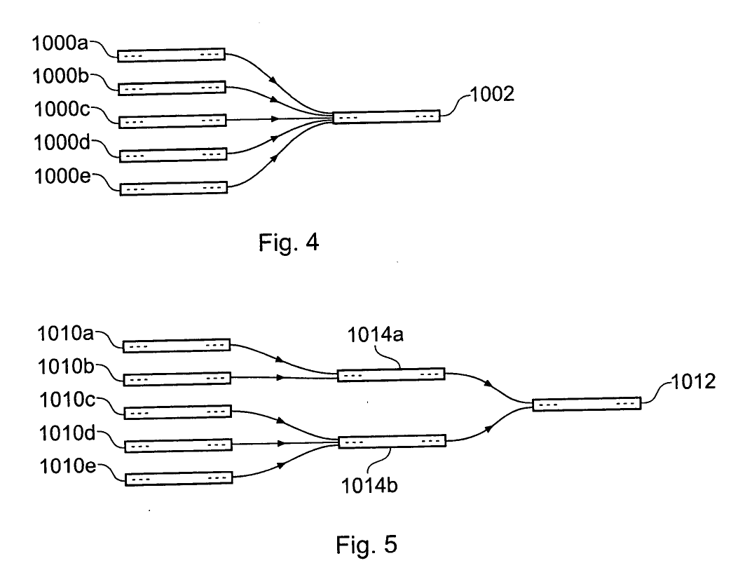

FIG. 4 schematically illustrates an example of audio mixing;

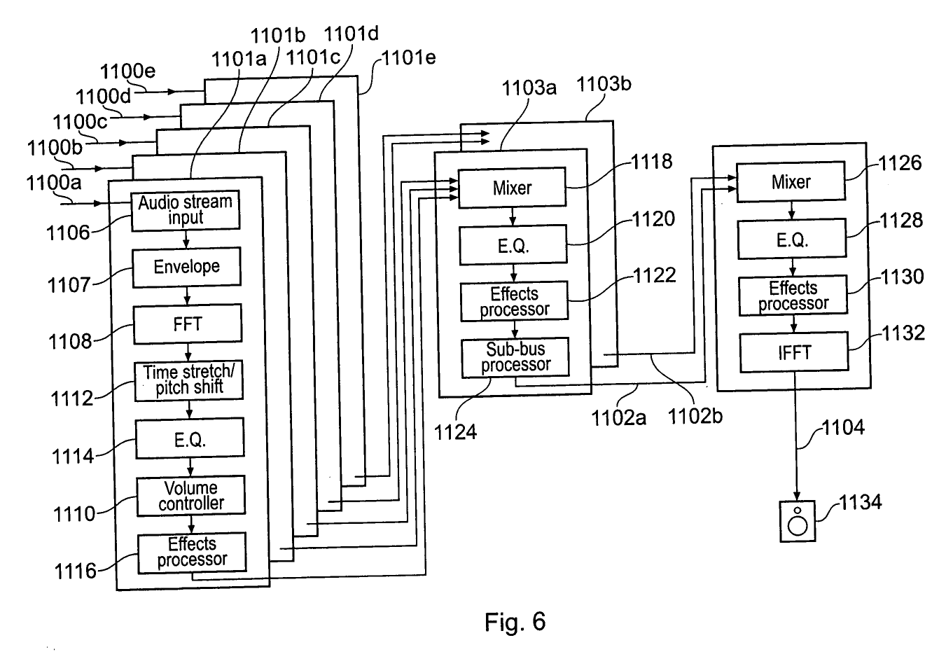

FIG. 5 schematically illustrates another example of audio mixing;

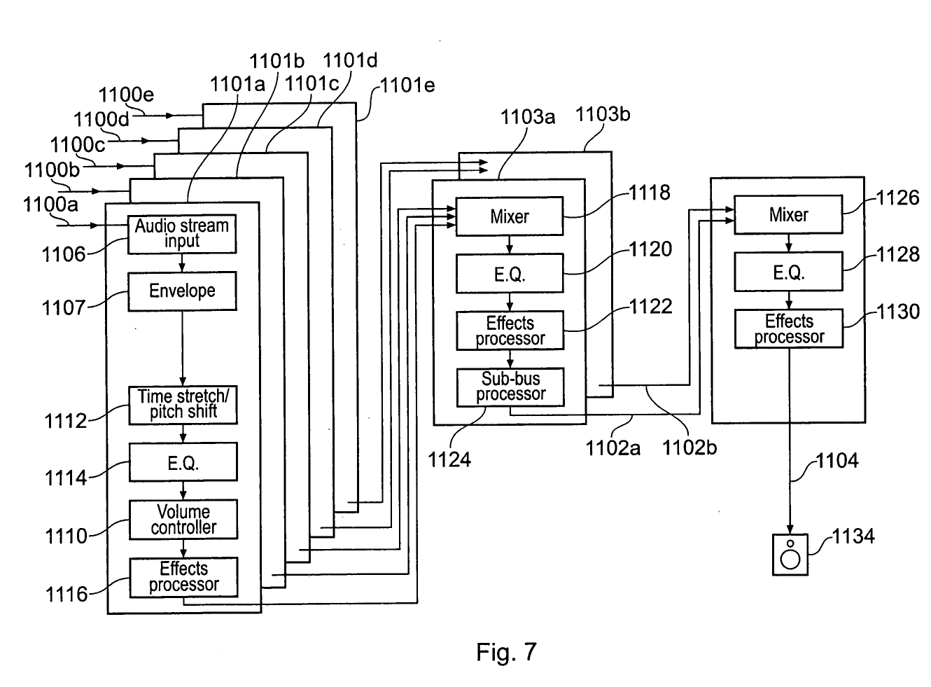

FIG. 6 schematically illustrates audio mixing and processing according to an embodiment of the invention;

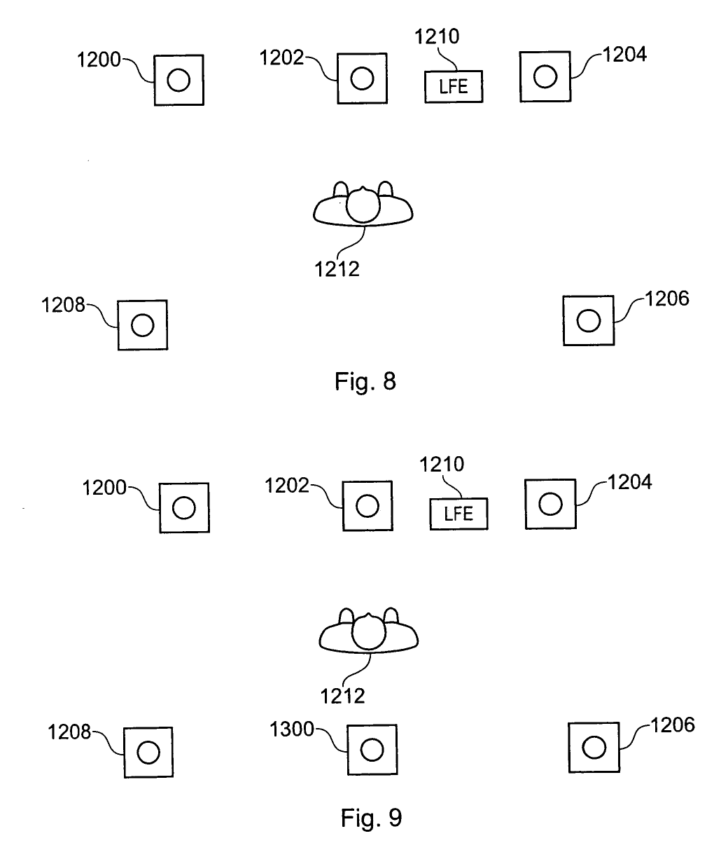

FIG. 7 schematically illustrates audio mixing and processing according to another embodiment of the invention;

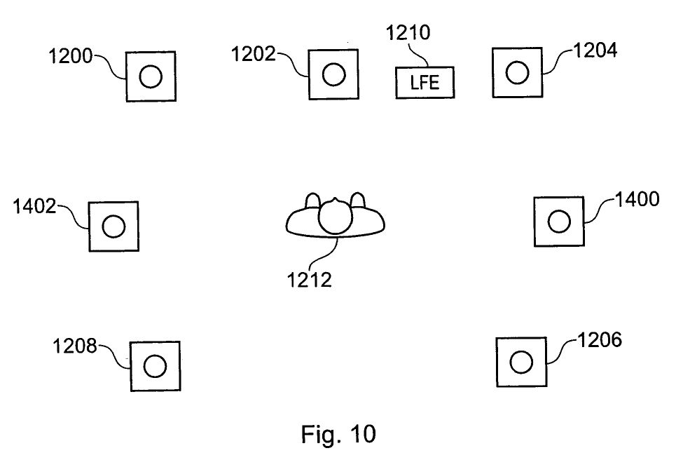

FIG. 8 schematically illustrates a loudspeaker configuration for a 5.1 surround-sound system;

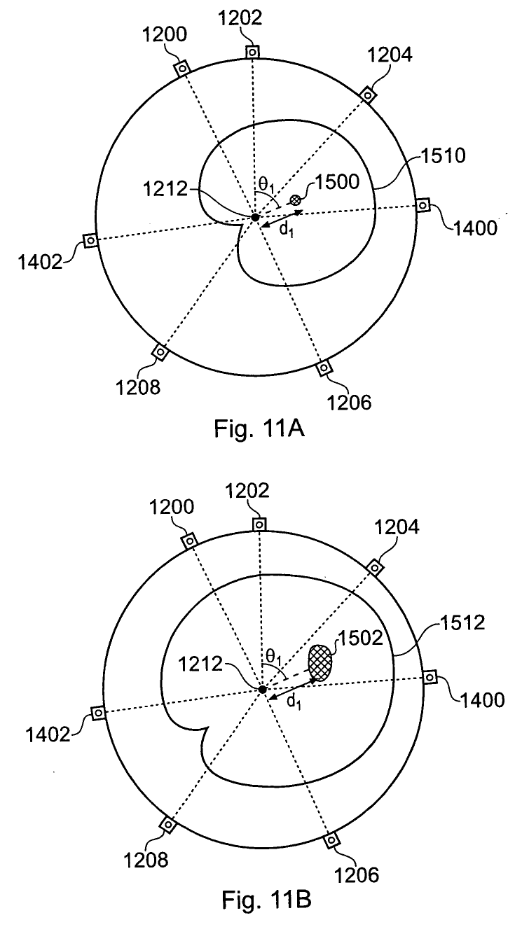

FIG. 9 schematically illustrates a loudspeaker configuration for a 6.1 surround-sound system;

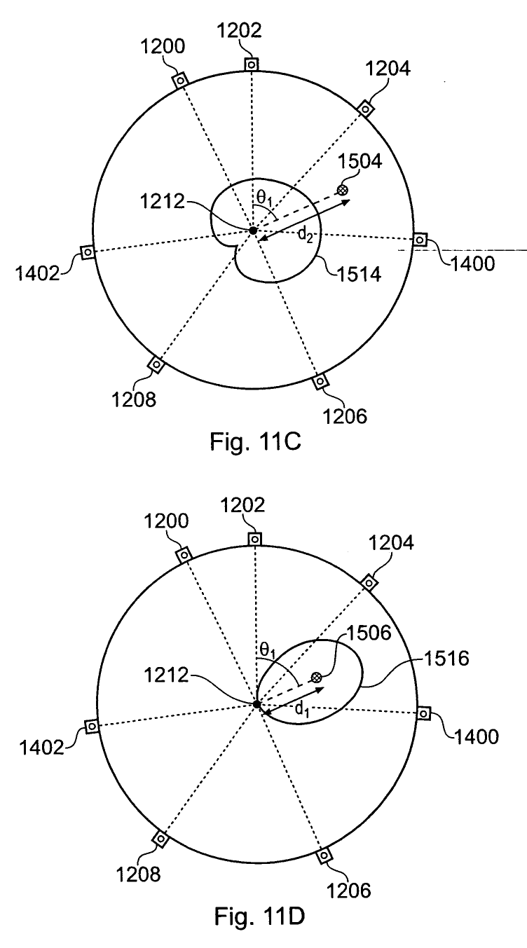

FIG. 10 schematically illustrates a loudspeaker configuration for a 7.1 surround-sound system;

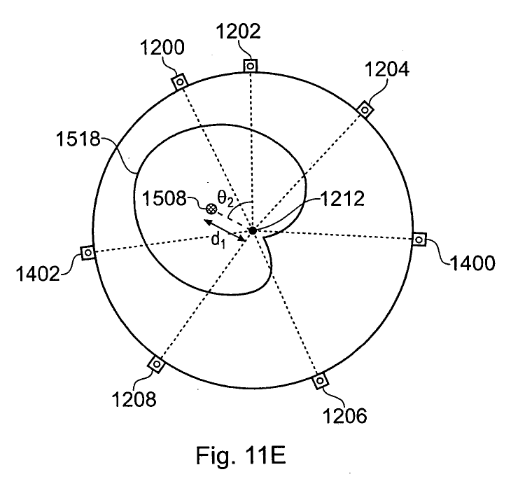

FIGS. 11A, 11B, 11C, 11D and 11E schematically illustrate loudspeaker volume control according to an embodiment of the invention; and

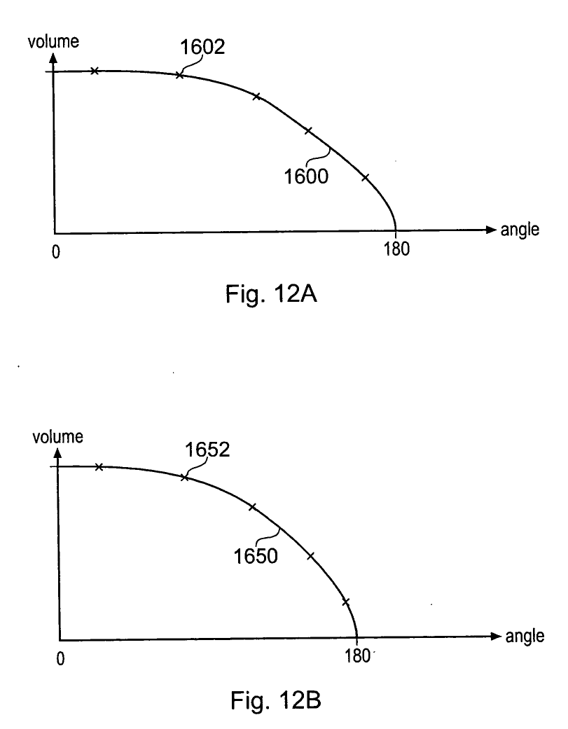

FIGS. 12A and 12 schematically illustrate how loudspeaker volume curves are calculated.

### DESCRIPTION OF THE PREFERRED EMBODIMENTS

FIG. 1 schematically illustrates the overall system architecture of the PlayStation2 games machine However, it will be appreciated that embodiments of the invention are not limited to the PlayStation2 games machine.

A system unit 10 is provided, with various peripheral devices connectable to the system unit.

The system unit 10 comprises: an Emotion Engine 100; a Graphics Synthesiser 200; a sound processor unit 300 having dynamic random access memory (DRAM); a read only memory (ROM) 400; a compact disc (CD) and digital versatile disc (DVD) reader 450; a Rambus Dynamic Random Access Memory (RDRAM) unit 500; an input/output processor (IOP) 700 with dedicated RAM 750. An (optional) external hard disk drive (HDD) 390 may be connected.

The input/output processor 700 has two Universal Serial Bus (USB) ports 715 and an iLink or IEEE 1394 port (iLink is the Sony Corporation implementation of the IEEE 1394 standard). The IOP 700 handles all USB, iLink and game controller data traffic. For example when a user is playing a game, the IOP 700 receives data from the game controller and directs it to the Emotion Engine 100 which updates the current state of the game accordingly. The IOP 700 has a Direct Memory Access (DMA) architecture to facilitate rapid data transfer rates. DMA involves transfer of data from main memory to a device without passing it through the CPU. The USB interface is compatible with Open Host Controller Interface (OHCI) and can handle data transfer rates of between 1.5 Mbps and 12 Mbps. Provision of these interfaces means that the PlayStation2 is potentially compatible with peripheral devices such as video cassette recorders (VCRs), digital cameras, microphones, set-top boxes, printers, keyboard, mouse and joystick.

Generally, in order for successful data communication to occur with a peripheral device connected to a USB port 715, an appropriate piece of software such as a device driver should be provided. Device driver technology is very well known and will not be described in detail here, except to say that the skilled man will be aware that a device driver or similar software interface may be required in the embodiment described here.

In the present embodiment, a USB microphone 730 is connected to the USB port. It will be appreciated that the USB microphone 730 may be a hand-held microphone or may form part of a head-set that is worn by the human operator. The advantage of wearing a head-set is that the human operator's hand are free to perform other actions. The microphone includes an analogue-to-digital converter (ADC) and a basic hardware-based real-time data compression and encoding arrangement, so that audio data are transmitted by the microphone 730 to the USB port 715 in an appropriate format, such as 16-bit mono PCM (an uncompressed format) for decoding at the PlayStation 2 system unit 10.

Apart from the USB ports, two other ports 705, 710 are proprietary sockets allowing the connection of a proprietary non-volatile RAM memory card 720 for storing game-related information, a hand-held game controller 725 or a device (not shown) mimicking a hand-held controller, such as a dance mat.

The system unit 10 may be connected to a network adapter 805 that provides an interface (such as an Ethernet interface) to a network. This network may be, for example, a LAN, a WAN or the Internet. The network may be a general network or one that is dedicated to game related communication. The network adapter 805 allows data to be transmitted to and received from other system units 10 that are connected to the same network, (the other system units 10 also having corresponding network adapters 805).

The Emotion Engine 100 is a 128-bit Central Processing Unit (CPU) that has been specifically designed for efficient simulation of 3 dimensional (3D) graphics for games applications. The Emotion Engine components include a data bus, cache memory and registers, all of which are 128-bit. This facilitates fast processing of large volumes of multi-media data. Conventional PCs, by way of comparison, have a basic 64-bit data structure. The floating point calculation performance of the PlayStation2 is 6.2 GFLOPs. The Emotion Engine also comprises MPEG2 decoder circuitry which allows for simultaneous processing of 3D graphics data and DVD data. The Emotion Engine performs geometrical calculations including mathematical transforms and translations and also performs calculations associated with the physics of simulation objects, for example, calculation of friction between two objects. It produces sequences of image rendering commands which are subsequently utilised by the Graphics Synthesiser 200. The image rendering commands are output in the form of display lists. A display list is a sequence of drawing commands that specifies to the Graphics Synthesiser which primitive graphic objects (e.g. points, lines, triangles, sprites) to draw on the screen and at which co-ordinates. Thus a typical display list will comprise commands to draw vertices, commands to shade the faces of polygons, render bitmaps and so on. The Emotion Engine 100 can asynchronously generate multiple display lists.

The Graphics Synthesiser 200 is a video accelerator that performs rendering of the display lists produced by the Emotion Engine 100. The Graphics Synthesiser 200 includes a graphics interface unit (GIF) which handles, tracks and manages the multiple display lists. The rendering function of the Graphics Synthesiser 200 can generate image data that supports several alternative standard output image formats, i.e., NTSC/PAL, High Definition Digital TV and VESA. In general, the rendering capability of graphics systems is defined by the memory bandwidth between a pixel engine and a video memory, each of which is located within the graphics processor. Conventional graphics systems use external Video Random Access Memory (VRAM) connected to the pixel logic via an off-chip bus which tends to restrict available bandwidth. However, the Graphics Synthesiser 200 of the PlayStation2 provides the pixel logic and the video memory on a single high-performance chip which allows for a comparatively large 38.4 Gigabyte per second memory access bandwidth. The Graphics Synthesiser is theoretically capable of achieving a peak drawing capacity of 75 million polygons per second. Even with a full range of effects such as textures, lighting and transparency, a sustained rate of 20 million polygons per second can be drawn continuously. Accordingly, the Graphics Synthesiser 200 is capable of rendering a film-quality image.

The Sound Processor Unit (SPU) 300 is effectively the soundcard of the system which is capable of recognising 3D digital sound such as Digital Theater Surround (DTS®) sound and AC-3 (also known as Dolby Digital) which is the sound format used for DVDs.

A display and sound output device 305, such as a video monitor or television set with an associated loudspeaker arrangement 310, is connected to receive video and audio signals from the graphics synthesiser 200 and the sound processing unit 300.

The main memory supporting the Emotion Engine 100 is the RDRAM (Rambus Dynamic Random Access Memory) module 500 produced by Rambus Incorporated. This RDRAM memory subsystem comprises RAM, a RAM controller and a bus connecting the RAM to the Emotion Engine 100.

FIG. 2 schematically illustrates the architecture of the Emotion Engine 100 of FIG. 1. The Emotion Engine 100 comprises: a floating point unit (FPU) 104; a central processing unit (CPU) core 102; vector unit zero (VU0) 106; vector unit one (VU1) 108; a graphics interface unit (GIF) 110; an interrupt controller (INTC) 112; a timer unit 114; a direct memory access controller 116; an image data processor unit (IPU) 118; a dynamic random access memory controller (DRAMC) 120; a sub-bus interface (SIF) 122; and all of these components are connected via a 128-bit main bus 124.

The CPU core 102 is a 128-bit processor clocked at 300 MHz. The CPU core has access to 32 MB of main memory via the DRAMC 120. The CPU core 102 instruction set is based on MIPS III RISC with some MIPS IV RISC instructions together with additional multimedia instructions. MIPS III and IV are Reduced Instruction Set Computer (RISC) instruction set architectures proprietary to MIPS Technologies, Inc. Standard instructions are 64-bit, two-way superscalar, which means that two instructions can be executed simultaneously. Multimedia instructions, on the other hand, use 128-bit instructions via two pipelines. The CPU core 102 comprises a 16 KB instruction cache, an 8 KB data cache and a 16 KB scratchpad RAM which is a portion of cache reserved for direct private usage by the CPU.

The FPU 104 serves as a first co-processor for the CPU core 102. The vector unit 106 acts as a second co-processor. The FPU 104 comprises a floating point product sum arithmetic logic unit (FMAC) and a floating point division calculator (FDIV). Both the FMAC and FDIV operate on 32-bit values so when an operation is carried out on a 128-bit value ( composed of four 32-bit values) an operation can be carried out on all four parts concurrently. For example adding 2 vectors together can be done at the same time.

The vector units 106 and 108 perform mathematical operations and are essentially specialised FPUs that are extremely fast at evaluating the multiplication and addition of vector equations. They use Floating-Point Multiply-Adder Calculators (FMACs) for addition and multiplication operations and Floating-Point Dividers (FDIVs) for division and square root operations. They have built-in memory for storing micro-programs and interface with the rest of the system via Vector Interface Units (VIFs). Vector unit zero 106 can work as a coprocessor to the CPU core 102 via a dedicated 128-bit bus so it is essentially a second specialised FPU. Vector unit one 108, on the other hand, has a dedicated bus to the Graphics synthesiser 200 and thus can be considered as a completely separate processor. The inclusion of two vector units allows the software developer to split up the work between different parts of the CPU and the vector units can be used in either serial or parallel connection.

Vector unit zero 106 comprises 4 FMACS and 1 FDIV. It is connected to the CPU core 102 via a coprocessor connection. It has 4 Kb of vector unit memory for data and 4 Kb of micro-memory for instructions. Vector unit zero 106 is useful for performing physics calculations associated with the images for display. It primarily executes non-patterned geometric processing together with the CPU core 102.

Vector unit one 108 comprises 5 FMACS and 2 FDIVs. It has no direct path to the CPU core 102, although it does have a direct path to the GIF unit 110. It has 16 Kb of vector unit memory for data and 16 Kb of micro-memory for instructions. Vector unit one 108 is useful for performing transformations. It primarily executes patterned geometric processing and directly outputs a generated display list to the GIF 110.

The GIF 110 is an interface unit to the Graphics Synthesiser 200. It converts data according to a tag specification at the beginning of a display list packet and transfers drawing commands to the Graphics Synthesiser 200 whilst mutually arbitrating multiple transfer. The interrupt controller (INTC) 112 serves to arbitrate interrupts from peripheral devices, except the DMAC 116.

The timer unit 114 comprises four independent timers with 16-bit counters. The timers are driven either by the bus clock (at 1/16 or 1/256 intervals) or via an external clock. The DMAC 116 handles data transfers between main memory and peripheral processors or main memory and the scratch pad memory. It arbitrates the main bus 124 at the same time. Performance optimisation of the DMAC 116 is a key way by which to improve Emotion Engine performance. The image processing unit (IPU) 118 is an image data processor that is used to expand compressed animations and texture images. It performs I-PICTURE Macro-Block decoding, colour space conversion and vector quantisation. Finally, the sub-bus interface (SIF) 122 is an interface unit to the IOP 700. It has its own memory and bus to control I/O devices such as sound chips and storage devices.

FIG. 3 schematically illustrates the configuration of the Graphic Synthesiser 200. The Graphics Synthesiser comprises: a host interface 202; a set-up/rasterizing unit; a pixel pipeline 206; a memory interface 208; a local memory 212 including a frame page buffer 214 and a texture page buffer 216; and a video converter 210.

The host interface 202 transfers data with the host (in this case the CPU core 102 of the Emotion Engine 100). Both drawing data and buffer data from the host pass through this interface. The output from the host interface 202 is supplied to the graphics synthesiser 200 which develops the graphics to draw pixels based on vertex information received from the Emotion Engine 100, and calculates information such as RGBA value, depth value (i.e. Z-value), texture value and fog value for each pixel. The RGBA value specifies the red, green, blue (RGB) colour components and the A (Alpha) component represents opacity of an image object. The Alpha value can range from completely transparent to totally opaque. The pixel data is supplied to the pixel pipeline 206 which performs processes such as texture mapping, fogging and Alpha-blending and determines the final drawing colour based on the calculated pixel information.

The pixel pipeline 206 comprises 16 pixel engines PE1, PE2 . . . , PE16 so that it can process a maximum of 16 pixels concurrently. The pixel pipeline 206 runs at 150 MHz with 32-bit colour and a 32-bit Z-buffer. The memory interface 208 reads data from and writes data to the local Graphics Synthesiser memory 212. It writes the drawing pixel values (RGBA and Z) to memory at the end of a pixel operation and reads the pixel values of the frame buffer 214 from memory. These pixel values read from the frame buffer 214 are used for pixel test or Alpha-blending. The memory interface 208 also reads from local memory 212 the RGBA values for the current contents of the frame buffer. The local memory 212 is a 32 Mbit (4 MB) memory that is built-in to the Graphics Synthesiser 200. It can be organised as a frame buffer 214, texture buffer 216 and a 32-bit Z-buffer 215. The frame buffer 214 is the portion of video memory where pixel data such as colour information is stored.

The Graphics Synthesiser uses a 2D to 3D texture mapping process to add visual detail to 3D geometry. Each texture may be wrapped around a 3D image object and is stretched and skewed to give a 3D graphical effect. The texture buffer is used to store the texture information for image objects. The Z-buffer 215 (also known as depth buffer) is the memory available to store the depth information for a pixel. Images are constructed from basic building blocks known as graphics primitives or polygons. When a polygon is rendered with Z-buffering, the depth value of each of its pixels is compared with the corresponding value stored in the Z-buffer. If the value stored in the Z-buffer is greater than or equal to the depth of the new pixel value then this pixel is determined visible so that it should be rendered and the Z-buffer will be updated with the new pixel depth. If however the Z-buffer depth value is less than the new pixel depth value the new pixel value is behind what has already been drawn and will not be rendered.

The local memory 212 has a 1024-bit read port and a 1024-bit write port for accessing the frame buffer and Z-buffer and a 512-bit port for texture reading. The video converter 210 is operable to display the contents of the frame memory in a specified output format.

FIG. 4 schematically illustrates an example of audio mixing. Five input audio streams 1000a, 1000b, 1000c, 1000d, 1000e are mixed to produce a single output audio stream 1002. This mixing is performed by the sound processor unit 300. The input audio streams 1000 may come from a variety of sources, such as one or more microphones 730 and/or a CD/DVD disk as read by the reader 450. Although FIG. 4 does not show any audio processing being performed on the input audio streams 1000 or on the output audio stream 1002 other than the mixing of the input audio streams 1000, it will be appreciated that the sound processor unit 300 may perform a variety of other audio processing steps. It will also be appreciated that whilst FIG. 4 shows five input audio streams 1000 being mixed to produce a single output audio stream 1002, any other number of input audio streams 1000 could be used.

FIG. 5 schematically illustrates another example of audio mixing that may be performed by the sound processing unit 300. In a similar way to that shown in FIG. 4, five input audio streams 1010a1010b, 1010c, 1010d, are mixed together to form a single output audio stream 1012. However, as shown in FIG. 5, an intermediate stage of mixing is performed by the sound processor unit 300. Specifically, two input audio streams 1010a, 1010b are mixed to produce a preliminary audio stream 1014a, whilst the remaining three input audio streams 1010c, 1010d, 1010e are mixed to produce a preliminary audio stream 1014b. The preliminary audio streams 1014a and 1014b are then mixed to produce the output audio stream 1012 One advantage of the mixing operation shown in FIG. 5 over that shown in FIG. 4 is that if some of the input audio streams 1010, such as the first two input audio streams 1010a, 1010b, each require the same audio processing to be performed, then they may be mixed together to form a single preliminary audio stream 1014a on which that audio processing may be performed. In this way, a single audio processing step is performed on the single preliminary audio stream 1014a, rather than having to perform two audio processing steps, one on each of the input audio streams 1010a, 1010b. This therefore makes for more efficient audio processing.

FIG. 6 schematically illustrates audio mixing and processing according to an embodiment of the invention. Three input audio streams 1100a, 1100b, 1100c are mixed to produce a preliminary audio stream 1102a. Two other input audio streams 1100d, 1100e are mixed to produce another preliminary audio stream 1102b. The preliminary audio streams 1102a, 1102b are then mixed to produce an output audio stream 1104. It will be appreciated that whilst FIG. 6 illustrates three input audio streams 1100a, 1100b, 1100c being mixed to form one of the prelimary audio streams 1102a and shows two different input audio streams 1100d, 1100e being mixed to form a separate preliminary audio stream 1102b, the actual configuration of the mixing may vary in dependence upon the particular requirements of the audio processing. Indeed, there may be a different number of input audio streams 1100 and a different number of preliminary audio streams 1102. Furthermore, one or more of the input audio streams 1100 may contribute to two or more of the preliminary audio streams 1102.

Each of the input audio streams 1100a, 1100b, 1100c, 1100d, 1100e may comprise one or more audio channels.

The initial processing performed on an individual input audio stream 1100 will now be described. Each of the input audio streams 1100a, 1100b, 1100c, 1100d, 1100e is processed by a respective processor 1101a, 1101b, 1101c, 1101d, 1101e which may be implemented as part of the functionality of the PlayStation 2 games machine described above, as respective stand-alone digital signal processors, as software-controlled operations of a general data processor capable of handling multiple concurrent operations, and so on. It will of course be appreciated that the PlayStation2 games machine is merely a useful example of an apparatus which could perform some or all of this functionality.

An input audio stream 1100 is received at an input 1106 of the corresponding processor 1101. The input audio stream 1100 may be received from a CD/DVD disk via the reader 450 or it may be received via the microphone 730 for example. Alternatively, the input audio stream 1100 may be stored in a RAM (such as the RAM 720).

The envelope of the input audio stream 1100 is modified/shaped by the envelope processor 1107.

A fast Fourier transform (FFT) processor 1108 then transforms the input audio stream 1100 from the time-domain to the frequency-domain. If the input audio stream 1100 comprises one or more audio channels, the FFT processor applies an FFT to each of the channels separately. The FFT processor 1108 may operate with any appropriately sized window of audio samples. Preferred embodiments use a window size of 1024 samples with the input audio stream 1100 having been sampled at 48 kHz. The FFT processor 1108 may output either floating point frequency-domain samples or frequency-domain samples that are limited to a fixed bit-width. It will be appreciated that whilst the FFT processor 1108 makes use of a FFT to transform the input audio stream from the time-domain to the frequency-domain, any other time-domain to frequency-domain transformation may be used.

It will be appreciated that the input audio stream 1100 may be supplied to the processor 1101 as frequency-domain data. For example, the input audio stream 1100 may have been initially created in the frequency-domain. In this case, the FFT processor 1108 is bypassed, the FFT processor 1108 only being used when the processor 1101 receives an input audio stream 1100 in the time-domain.

An audio processing unit 1112 then performs various audio processing on the frequency-domain converted input audio stream 1100. For example, the audio processing unit 1112 may perform time stretching and/or pitch shifting. When performing time stretching, the playing time of the input audio stream 1100 is altered without changing the actual pitch of the input audio stream 1100. When performing pitch shifting, the pitch of the input audio stream 1100 is altered without changing the playing time of the input audio stream 1100.

Once the audio processing unit 1112 has finished its processing on the frequency-domain converted input audio stream 1100, an equaliser 1114 performs frequency equalisation on the input audio stream 1100. Equalisation is a known technique and will not be described in detail herein.

After the equaliser 1114 has performed equalisation of the frequency-domain converted input audio stream 1100, the frequency-domain converted input audio stream 1100 is then output from the equaliser 1114 to a volume controller 1110. The volume controller 1110 serves to control the volume of the input audio stream 1100. This will be described in more detail later.

After the volume controller 1110 has performed its volume processing on the frequency-domain converted input audio stream 1100, an effects processor 1116 modifies the frequency-domain converted input audio stream 1100 in a variety of different ways (e.g. via equalisation on each of the audio channels of the input audio stream 1100) and mixes these modified versions together. This is used to generate a variety of effects, such as reverberation.

It will be appreciated that the audio processing performed by the envelope processor 1107, the volume controller 1110, the audio processing unit 1112, the equaliser 1114 and the effects processor 1116 may be performed in any order. Indeed, it is even possible that, for a particular audio processing effect, the processing performed by the envelope processor 1107, the volume controller 1110, the audio processing unit 1112, the equaliser 1114 or the effects processor 1116 may be bypassed. However, all of the processing following the FFT processor 1108 is undertaken in the frequency-domain, using the frequency-domain converted input audio stream 1100 that is produced by the FFT processor 1108.

The audio processing that is applied to each of the input audio streams 1100 may vary from stream to stream.

The generation of a preliminary audio stream 1102 will now be described. Each of the preliminary audio streams 1102a, 1102b is produced by a respective sub-bus 1103a, 1103b.

A mixer 1118 of a sub-bus 1103 receives one or more of the processed input audio streams 1100, represented in the frequency-domain, and produces a mixed version of these processed input audio streams 1100. In FIG. 6, the mixer 1118 of the first sub-bus 1103a receives processed versions of the input audio streams 1100a, 1100b, 1100c. The mixed audio stream is then passed to an equaliser 1120. The equaliser 1120 performs functions similar to the equaliser 1114. The output of the equaliser 1120 is then passed to an effects processor 1122. The processing performed by the effects processor 1122 is similar to the processing performed by the effects processor 1116.

A sub-bus processor 1124 receives the output from the effects processor 1122 and adjusts the volume of the output of the effects processor 1122 in accordance with control information received from one or more of the other sub-buses 1103 (often referred to as “ducking” or “side chain compression”). The sub-bus processor 1124 also provides control information to one or more of the other sub-buses 1103 so that those sub-buses 1103 may adjust the volume of their preliminary audio streams in accordance with the control information supplied by the sub-bus processor 1124. For example, the preliminary audio stream 1102a may relate to audio from a football match whilst the preliminary audio stream 1102b may relate to commentary for the football match. The sub-bus processor 1124 for each of the preliminary audio streams 1102a and 1102b may work together to adjust the volumes of the audio from the football match and the commentary so that the commentary may be faded in and out as appropriate.

Again, it will be appreciated that the audio processing performed by the equaliser 1120, the effects processor 1122 and the sub-bus processor 1124 may be performed in any order. Indeed, it is even possible that, for a particular audio processing effect, the processing performed by the equaliser 1120, the effects processor 1122 and the sub-bus processor 1124 may be bypassed. However, all of the processing is undertaken in the frequency-domain.

The generation of the final output audio stream will now be described. A mixer 1126 receives the preliminary audio streams 1102a and 1102b and mixes them to produce an initial mixed output audio stream. The output of the mixer 1126 is supplied to an equaliser 1128. The equaliser 1128 performs processing similar to that of the equaliser 1120 and the equaliser 1114. The output of the equaliser 1128 is supplied to an effects processor 1130. The effects processor 1130 performs processing similar to that of the effects processor 1122 and the effects processor 1116. Finally, the output of the effects processor 1130 is supplied to an inverse FFT processor 1132. The inverse FFT processor 1132 performs an inverse FFT to reverse the transformation applied by the FFT processor 1108, i.e. to transform the frequency-domain representation of the audio stream output by the effects processor 1130 to the time-domain representation. If the mixed output audio stream comprises one or more audio channels, the inverse FFT processor 1132 applies an inverse FFT to each of the channels separately. The time-domain representation output by the inverse FFT processor 1132 may then be supplied to an appropriate audio apparatus expecting to receive a time-domain audio signal, such as one or more loudspeakers 1134.

It will be appreciated that all of the audio processing performed between the FFT processor 1108 and the inverse FFT processor 1132 is performed in the frequency-domain and not the time-domain. As such, for each of the time-domain input audio streams 1100, there is only ever one transformation from the time-domain to the frequency-domain. Furthermore, there is only ever one transformation from the frequency-domain to the time-domain, and this is performed only for the final mixed output audio stream.

FIG. 7 schematically illustrates audio mixing and processing according to another embodiment of the invention. FIG. 7 is identical to FIG. 6 except that the FFT processor 1108 and the inverse FFT processor 1132 are not included in FIG. 7. Consequently, the audio mixing and processing according to the embodiment shown in FIG. 7 is performed in the time-domain and not the frequency-domain.

FIG. 8 schematically illustrates a loudspeaker configuration for a 5.1 surround-sound system. This system uses six loudspeakers: a front left loudspeaker 1200; a front centre loudspeaker 1202; a front right loudspeaker 1204; a back right loudspeaker 1206; a back left loudspeaker 1208; and a low frequency effects (LFE) loudspeaker 1210. For a given audio signal, the effect of surround-sound is created for a person at a listening location 1212 by controlling the volume at which that audio signal that is output by each of the loudspeakers 1200, 1202, 1204, 1206, 1208. For example, if the source of an audio signal is to be made to appear as if it is originating from a position to the front and left of the listening location 1212, then the volume of that audio signal will be output from the front left loudspeake 1200 at a greater volume than the output from the back right loudspeaker 1206. The positioning of the low frequency effects loudspeaker 1210 is not overly important to the surround-sound system. This is due to the fact that the human hearing system is not very good at determining the position of a source of low frequency audio signals. However, the positioning of the other loudspeakers 1200, 1202, 1204, 1206, 1208 is more important as the human hearing system is better at determining the position of a source of medium and high frequency audio signals.

FIG. 9 schematically illustrates a loudspeaker configuration for a 6.1 surround-sound system. This is similar to the loudspeaker configuration for the 5.1 surround-sound system shown in FIG. 8, except that in FIG. 9 there is an additional back centre loudspeaker 1300. This allows for improved directional resolution for audio signals appearing to have originated from behind the listening location 1212.

FIG. 10 schematically illustrates the loudspeaker configuration for a 7.1 surround-sound system. This is similar to the loudspeaker configuration for the 5.1 surround-sound system as shown in FIG. 8, except that in FIG. 10 there is an additional centre right loudspeaker 1400 and an additional centre left loudspeaker 1402. This allows for improved directional resolution for audio signals appearing to have originated from the sides of the listening location 1212.

It will be appreciated that other loudspeaker configurations are possible and those shown in FIGS. 8 to 10 merely serve as examples for use in embodiments of the invention.

FIGS. 8 to 10 show idealised positioning of the loudspeakers relative to the listening location 1212 so that the best surround-sound system effects can be achieved. However, it will be appreciated that, due to the configuration of a particular room in which the surround-sound system is located (for example the length of the room, the location of the walls or furniture within a room), it may not always be possible to arrange the loudspeakers as shown in FIGS. 8 to 10.

FIGS. 11A, 11B, 11C, 11D and 11E schematically illustrate loudspeaker volume control according to an embodiment of the invention. The loudspeakers 1200, 1202, 1204, 1206, 1208, 1400, 1402 are the loudspeakers shown in FIG. 10, arranged in a 7.1 surround-sound configuration. The low frequency effects loudspeaker 1210 is not shown in FIGS. 11A, 11B, 11C, 11D or 11E as its positioning is not crucial to surround-sound effects. As can be seen in FIGS. 11A, 11B, 11C, 11D and 11E, the loudspeakers 1200, 1202, 1204, 1206, 1208, 1400, 1402 are not in their ideal configuration. For example, the front left loudspeaker 1200 is positioned closer to the front centre loudspeaker 1202 than the front right loudspeaker 1204. The user informs the surround-sound system (for example the sound processor unit 300) of the positioning of the loudspeakers 1200, 1202, 1204, 1206, 1208, 1400, 1402 via an input (such as the controller 725). This positioning information may assume a variety of forms. For example, the user may input the angles that are subtended at the listening location 1212 by the loudspeaker locations and a reference point. This reference point may be one of the loudspeakers 1200, 1202, 1204, 1206, 1208, 1400, 1402 or some other point. Alternatively, the user may input the angles that are subtended at the listening location 1212 by adjacent loudspeakers 1200, 1202, 1204, 1206, 1208, 1400, 1402. This may occur once at a calibration stage prior to using the surround-sound system or may occur each time the surround-sound system is used. The functionality to perform this calibration and the subsequent surround-sound processing may be stored within the sound processor unit 300 or may be delivered to the sound processor unit 300 via a CD/DVD disk as read by the reader 450.

FIG. 11 A shows a volume curve 1510 that is used to produce a surround-sound effect to simulate a sound source 1500 located a distance d₁ away from the listening location 1212, the angle subtended at the listening location 1212 by the centre of the sound source 1500 and the front centre loudspeaker 1202 being an angle θ₁. The information specifying the location of the sound source 1500 (i.e. d₁ and θ₁) may be stored on a CD/DVD disk and read by the reader 450 for supply to the sound processor unit 300. It will be appreciated that this information may be specified by co-ordinates other than the distance d₁ and the angle θ₁. Additionally, the actual volume curve may be calculated by the sound processor unit 300 or the volume curve may be provided to the sound processor unit 300 via a CD/DVD disk as read by the reader 450.

As can be seen, the volume output by the front right loudspeaker 1204 and the centre right loudspeaker 1400 is larger than the volume output by the other loudspeakers 1200, 1202, 1206, 1208, 1402. The centre left loudspeaker 1402 and the back left loudspeaker 1208 output the lowest volume for the sound source 1500 whilst the front left loudspeaker 1200, the front centre loudspeaker 1202 and the back right loudspeaker 1206 output medium level volumes for the sound source 1500. The generation of the volume curve 1510 will be described in greater detail later.

FIG. 11B shows a volume curve 1512 that is used to produce a surround-sound effect to simulate a sound source 1502 located the distance d₁ from the listening position 1212, the angle subtended at the listening location 1212 by the centre of the sound source 1502 and the front centre loudspeaker 1202 being the angle θ₁. The sound source 1502 in FIG. 11B is intended to appear larger than the sound source 1500 in FIG. 11A. For example, the sound source 1500 could represent a bee whilst the sound source 1502 could represent a waterfall. As can be seen, the volume curve 1512 is a different shape to the volume curve 1510. For example, volume levels output by the back left loudspeaker 1208 and the centre left loudspeaker 1402 are appreciably larger in FIG. 11B than in FIG. 11A.

FIG. 11C shows a volume curve 1514 that is used to produce a surround-sound effect to simulate a sound source 1504 located a distance d₂ from the listening position 1212, the angle subtended at the listening location 1212 by the centre of the sound source 1504 and the front centre loudspeaker 1202 being the angle θ₁. The sound source 1504 is intended to appear to be the same size as the sound source 1500 but at a larger distance away from the listening location 1212 (i.e. d₂>d₁). As can be seen, the volume curve 1514 is substantially the same shape, but appreciably smaller than, the volume curve 1510.

FIG. 11D shows a volume curve 1516 that is used to produce a surround-sound effect to simulate a sound source 1506 located the distance d₁ from the listening position 1212, the angle subtended at the listening location 1212 by the centre of the sound source 1506 and the front centre loudspeaker 1202 being the angle θ₁. The sound source 1506 is intended to appear to be the same size as the sound source 1500 but located in a larger “virtual room” in FIG. 11D than in FIG. 11A. This “virtual room” size may be used to simulate the acoustic variation between, say, a concert hall and a broom closet, i.e. the volume curve 1516 is dependent upon the environment in which the sound source 1506 is intended to appear to be located.

Finally, FIG. 11E shows a volume curve 1518 that is used to produce a surround-sound effect to simulate a sound source 1508 located the distance d₁ from the listening position 1212, the angle subtended at the listening location 1212 by the centre of the sound source 1504 and the front centre loudspeaker 1202 being the angle θ₂. The sound source 1504 is intended to appear to be the same size as the sound source 1500 and at the same distance away from the listening location 1212, but with a different subtended angle (θ₂≠θ₁). As can be seen, the volume curve 1518 is the same as the volume curve 1510, except that it has been rotated around the listening location 1212 to cater for the difference between θ₂ and θ₁.

FIGS. 12A and 12B schematically illustrate how the volume curves 1510, 1512, 1514, 1516, 1518 are calculated. FIG. 12A represents an angle roll-off curve 1600, in which the x-axis represents the angle centred at the listening location 1212 and moving in a clockwise or anti-clockwise direction away from the sound source 1500, 1502, 1504, 1506, 1508. As can be seen from FIG. 12A, at 0° (i.e. directly in front of and in line with the listening location 1212 and the sound source 1500, 1502, 1504, 1506, 1508) the largest volume for the audio signal that corresponds to the sound source 1500, 1502, 1504, 1506, 1508 is used. Conversely, at 180° (i.e. directly behind and in line with the listening location 1212 and the sound source 1500, 1502, 1504, 1506, 1508) the lowest volume for the audio signal that corresponds to the sound source 1500, 1502, 1504, 1506, 1508 is used.

The angle roll-off curve 1600 may be defined by one or more reference points 1602 with, say, a straight line joining the reference points. Alternatively, the angle roll-off curve 1600 may be a smooth curve defined by an equation. An example of the use of the angle-roll off curve 1600 will be given in detail later.

FIG. 12B represents a distance roll-off curve 1650, in which the x-axis represents the angle centred at the listening location 1212 and moving in a clockwise or anti-clockwise direction away from the sound source 1500, 1502, 1504, 1506, 1508. As can be seen from FIG. 12B, at 0° (i.e. directly in front of and in line with the listening location 1212 and the sound source 1500, 1502, 1504, 1506, 1508) the largest volume for the audio signal that corresponds to the sound source 1500, 1502, 1504, 1506, 1508 is used. Conversely, at 180° (i.e. directly behind and in line with the listening location 1212 and the sound source 1500, 1502, 1504, 1506, 1508) the lowest volume for the audio signal that corresponds to the sound source 1500, 1502, 1504, 1506, 1508 is used.

The distance roll-off curve 1650 may be defined by one or more reference points 1652 with, say, a straight line joining the reference points. Alternatively, the distance roll-off curve 1650 may be a smooth curve defined by an equation.

It will be appreciated that the volume curves 1510, 1512, 1514, 1516, 1518 are produced through a combination of the angle-roll off curve 1600 and the distance roll-off curve 1650 shown in FIGS. 12A and 12B, as will be described with reference to the code segment given below.

```
float GetSpeakerVolume(unsigned int objectAngle,
                    float objectSize,
                    float objectDistance,
                    float roomSize)
{
  unsigned int finalSize, finalDistance;
  float sizeAmplitude, distanceAmpliture, finalAmplitude;
  float sizef, distancef, roomsizef;
  objectSize = 100 − objectSize;
  sizef = (float) objectSize / 100.0f;
  sizef *= sizef;
  distancef = (float) objectDistance / 100.0f;
  roomsizef = (float) roomSize / 100.0f;
  roomsizef /= 0.999999f − roomsizef;
  if(objectAngle > 179)
    objectAngle = (360 − objectAngle);
  finalSize = (unsigned int)(objectAngle*sizef*roomsizef);
  if(finalSize > 179)
    sizeAmplitude = 0;
  else
    sizeAmplitude = rollOffTable[finalSize];
  finalDistance = (unsigned int)(objectAngle*distancef*roomsizef);
  if(finalDistance > 179)
    distanceAmplitude = 0;
  else
    distanceAmplitude = distanceTable[finalDistance];
  finalAmplitude = sizeAmplitude * distanceAmpliture;
  finalAmplitude *= (1.0f − distancef);
  return finalAmplitude;
}
              float GetVolume(int speakerAngle,
              int objectAngle,
              int objectSize,
              int objectDistance,
              int roomSize)
{
  speakerAngle = speakerAngle − objectAngle;
  speakerAngle %= 360;
  if(speakerAngle < 0) speakerAngle += 360;
  return GetSpeakerVolume(speakerAngle, objectSize,
                          objectDistance, roomSize);
}
```

The function GetVolume returns the volume level for a loudspeaker given: the angle speakerAngle subtended by the loudspeaker and a reference point (such as the front centre loudspeaker 1202) at the listening location 1212; the angle objectAngle subtended by the sound source 1500, 1502, 1504, 1506, 1508 and the reference point at the listening location 1212; the size objectSize of the sound source 1500, 1502, 1504, 1506, 1508; the distance objectDistance of the sound source 1500, 1502, 1504, 1506, 1508 away from the listening location 1212; and size roomSize of the virtual room. The angles speakerAngle and objectAngle are measured in degrees, whilst the values for objectsize, objectDistance and roomSize range from 0 to 100 (0 being the smallest size, 100 being the largest size).

The function GetVolume calculates the angle subtended at the listening location 1212 by the sound source 1500, 1502, 1504, 1506 1508 and the loudspeaker and calls the function GetSpeakerVolume, with this angle as the parameter objectAngle, together with parameters objectSize, objectDistance and roomSize.

The size of the sound source 1500, 1502, 1504, 1506 1508 is converted to a value sizef that lies in the range 0 to 1, with 1 being the largest size, 0 being the smallest size, and sizef varying according to the square of the value of objectSize. The distance of the sound source 1500, 1502, 1504, 1506, 1508 from the listening location 1212 is converted to a value distancef that lies in the range 0 to 1. The size of the virtual room is converted to a value roomsizef that lies in the range 0 to infinity.

The x-axis value (to be used for the current loudspeaker) on the angle roll-off curve 1600 of FIG. 12A is calculated as the angle objectAngle*sizef*roomsizef. (In the code above, the array rollOffTable[ ] represents the angle roll-off curve 1600.

The x-axis value (to be used for the current loudspeaker) on the distance roll-off curve 1650 of FIG. 12B is calculated as the angle objectAngle*distancef*roomsizef. (In the code above, the array distanceTable [ ] represents the distance roll-off curve 1650.

The values obtained from the angle roll-off curve 1600 and the distance roll-off curve 1650 are then multiplied together. The final output loudspeaker volume finalAmplitude is then obtained by multiplying this result by a factor of (1.0-distancef).

As mentioned, each of the input audio streams 1100 shown in FIGS. 6 and 7 may comprise one or more audio channels. Typically, each of the audio channels will be a mono channel made up of PCM format audio data. As mentioned, in order to produce surround-sound effects, the volume at which each of these mono channels is output from each of the loudspeakers 1200, 1202, 1204, 1206, 1208, 1400, 1402 must be controlled. Additionally, the volume of the low frequency effects loudspeaker 1210 must also be controlled. Therefore, to provide the surround-sound effects with this loudspeaker configuration, 8 volume registered are provided for each of the audio channels, each register corresponding to a respective loudspeaker 1200, 1202, 1204, 1206, 1208, 1210, 1400, 1402. Therefore, if there are, for example, 8 audio channels in an input audio stream 1100, a total of 64 volume registers are used to provide the surround-sound effects.

For example, for a given audio channel, the 8 registers may correspond to the loudspeakers 1200, 1202, 1204, 1206, 1208, 1210, 1400, 1402 as shown in Table 1 below:

TABLE 1

| | Register | | | | | | | |
|---|---|---|---|---|---|---|---|---|
| | 0 | 1 | 2 | 3 | 4 | 5 | 6 | 7 |
| Speaker | 1200 | 1202 | 1204 | 1400 | 1206 | 1208 | 1402 | 1210 |

The volume controller 1110 adjusts the values stored in the volume registers for an audio channel according to the surround-sound effect desired for that audio channel, such as the size and position of the sound source 1500, 1502, 1504, 1506, 1508. The volume controller 1110 uses the volume curve 1510, 1512, 1514, 1516, 1518 corresponding to the sound source 1500, 1502, 1504, 1506, 1508 to provide values for the registers given the known position of the loudspeakers 1200, 1202, 1204, 1206, 1208, 1210, 1400, 1402.

For example, the registers may be provided with values as shown in Table 2 below, given the volume curves shown in FIG. 11A, 11B, 11C, 11D and 11E.

TABLE 2

| | Register (speaker) | | | | | | | |
|---|---|---|---|---|---|---|---|---|
| | 0 | 1 | 2 | 3 | 4 | 5 | 6 | 7 |
| | (1200) | (1202) | (1204) | (1400) | (1206) | (1208) | (1402) | (1210) |
| FIG. 11A values | 0.63 | 0.66 | 0.69 | 0.67 | 0.60 | 0.27 | 0.17 | 0.5 |
| FIG. 11B values | 0.66 | 0.67 | 0.70 | 0.68 | 0.64 | 0.52 | 0.49 | 0.5 |
| FIG. 11C values | 0.51 | 0.54 | 0.57 | 0.55 | 0.46 | 0.11 | 0.04 | 0.5 |
| FIG. 11D values | 0 | 0 | 0.67 | 0.44 | 0 | 0 | 0 | 0.5 |
| FIG. 11E values | 0.67 | 0.65 | 0.57 | 0.27 | 0.30 | 0.60 | 0.67 | 0.5 |

The volume controller 1110 then modifies the volume of each of the audio channels of the input audio stream 1100 in accordance with the corresponding register value.

The audio processing performed may be undertaken in software, hardware or a combination of hardware and software. In so far as the embodiments of the invention described above are implemented, at least in part, using software-controlled data processing apparatus, it will be appreciated that a computer program providing such software control and a storage medium by which such a computer program is stored are envisaged as aspects of the present invention.

Although illustrative embodiments of the invention have been described in detail herein with reference to the accompanying drawings, it is to be understood that the invention is not limited to those precise embodiments, and that various changes and modifications can be effected therein by one skilled in the art without departing from the spirit and scope of the invention as defined by the appended claims.

We claim:

1. An audio processing apparatus operable to determine, for each loudspeaker of a plurality of loudspeakers, the respective volume at which an audio signal is to be output through that loudspeaker, said volume being determined in dependence on a desired characteristic of a simulated source for said audio signal, the position of a listening location for listening to said audio signal and the position of said loudspeaker.

2. An audio processing apparatus according to claim 1, in which said desired characteristic of said simulated source for said audio signal is a desired position of said simulated source relative to said listening location and/or a desired size of said simulated source and/or a desired size of a simulated environment containing said simulated source.

3. An audio processing apparatus according to claim 1, operable to determine said loudspeaker volumes so that the combination of the loudspeaker outputs, if heard at said listening location, would appear to have originated from a simulated source with said desired characteristics.

4. An audio processing apparatus according to claim 2, operable, for each loudspeaker, to determine said respective volume of said audio signal output by that loudspeaker in dependence upon the angle subtended at said listening location by said position of said loudspeaker and said desired position of said simulated source.

5. An audio processing apparatus according to claim 2, operable, for each loudspeaker, to determine said respective volume of said audio signal output by that loudspeaker in dependence upon the distance of the desired position of the simulated source from the position of the listening location.

6. An audio processing apparatus according to claim 1, in which the position of a loudspeaker is determined by the angle subtended at the listening location by the loudspeaker and a reference point.

7. An audio processing apparatus according to claim 6, in which the reference point is one of the loudspeakers.

8. An audio processing apparatus according to claim 1, comprising:
a loudspeaker positioning input operable to receive information indicative of the position of the loudspeakers.

9. An audio processing apparatus according to claim 8, in which the information indicative of the position of the loudspeakers is supplied by a user of the audio processing apparatus.

10. An audio processing apparatus according to claim 9, comprising:
a characteristic information input operable to receive information indicative of the desired characteristics of the simulated source for the audio signal.

11. An audio processing system comprising:
an audio data source operable to provide an audio signal and characteristic information indicative of a desired characteristic of a simulated source for the audio signal;
an audio processing apparatus according to claim 1 operable to receive the characteristic information; and
a plurality of loudspeakers operable to output the audio signal, the output volumes of the loudspeakers being controlled in accordance with the loudspeaker volumes determined by the audio processing apparatus.

12. An audio processing method for determining, for each loudspeaker of a plurality of loudspeakers, the respective volume at which an audio signal is to be output through that loudspeaker, the method comprising the step of:
determining, for each loudspeaker, the respective volume in dependence on a desired characteristic of a simulated source for the audio signal, the position of a listening location for listening to the audio signal and the position of the loudspeaker.

13. Computer software comprising program code for carrying out a method according to claim 12.

14. A providing medium for providing computer software according to claim 13.

15. A providing medium according to claim 14, in which the providing medium is a storage medium.

16. A providing medium according to claim 14, in which the providing medium is a transmission medium.
